(19) United States
(12) Patent Application Publication
(10) Pub. No.: US 2020/0023411 A1
(43) Pub. Date: Jan. 23, 2020

(54) PRESSURE WASHER

(71) Applicant: BRIGGS & STRATTON CORPORATION, Wauwatosa, WI (US)

(72) Inventors: Christopher Michael Krajewski, West Allis, WI (US); Ryan Thomas Hahn, Elm Grove, WI (US)

(73) Assignee: BRIGGS & STRATTON CORPORATION, Wauwatosa, WI (US)

(21) Appl. No.: 16/516,809

(22) Filed: Jul. 19, 2019

Related U.S. Application Data
(60) Provisional application No. 62/700,969, filed on Jul. 20, 2018.

(51) Int. Cl. B08B 3/02; F04B 53/00

(52) U.S. Cl. CPC B08B 3/024; F04B 17/05; F04B 53/001

(57) ABSTRACT

An enclosed pressure washer system includes an engine having a horizontal output shaft, an exhaust system having a muffler and an exhaust outlet port in the muffler, a fan rotatably coupled to the horizontal output shaft, a starting system structured to start the engine, and a pump rotatably coupled to the engine via a non-metallic connector. The starting system includes a flywheel, a battery, and a starting device structured to start the engine. The pump includes an inlet which water enters from an inlet conduit and an outlet which pressurized water exits to an outlet conduit. The pressure washer system further includes an enclosure structured to house the engine, muffler, and pump and a sound absorbing case which surrounds the engine, pump, and the muffler and allows the exit of exhaust gas. The pump, flywheel, and fan are positioned on a side of the engine proximate the horizontal output shaft.

### CROSS-REFERENCE TO RELATED PATENT APPLICATION

This application claims the benefit of U.S. Provisional Patent Application No. 62/700,969, filed Jul. 20, 2018, which is incorporated herein by reference in its entirety.

### BACKGROUND

The present application relates generally to the field of pressure washers. More specifically the present application relates to a pressure washer with reduced noise emission.

Conventionally, pressure washers contain a water pump which is driven by an internal combustion engine and are used for cleaning applications that require high-pressure spray, such as car-washing, concrete washing, house washing, etc. The water pump used in the pressure washer includes an inlet connector through which water is supplied to the pump and an outlet connector from which high-pressure water exits. Pressure washers that use an internal combustion engine may be very loud during use.

To use a pressure washer, a water supply (e.g., a garden hose) is attached to the inlet connector, and a pressure washer spray gun is coupled to a pressure washer hose which is attached to the outlet connector of the pump. This enables the user to direct the pressurized water towards the area to be cleaned. However, in order to hold a conversation at a normal volume level or to hear anything above the noise of the pressure washer, the user must shut the pressure washer off completely, including shutting off the engine. Accordingly, it would be advantageous to have a pressure washer with a reduced decibel level.

### SUMMARY

One embodiment of the invention relates to an enclosed pressure washer system. The enclosed pressure washer system includes an internal combustion engine having a horizontal output shaft, an exhaust system having a muffler and an exhaust outlet port in the muffler, a fan rotatably coupled to the horizontal output shaft, and a starting system structured to start the engine. The starting system includes a flywheel rotatably coupled to the engine, a battery, and a starting device structured to start the engine by rotating the flywheel. The pressure washer system further includes a pump rotatably coupled to the engine via a non-metallic connector. The pump includes an inlet which water enters from an inlet conduit and an outlet, which pressurized water exits to an outlet conduit. The pressure washer system further includes an enclosure structured to house the engine, muffler, and pump, and a sound absorbing case which surrounds the engine, pump, and the muffler and allows the exit of exhaust gas. The pump, flywheel, and fan are positioned on a side of the engine proximate the horizontal output shaft.

Another embodiment of the invention relates to a pressure washer system. The pressure washer system includes an internal combustion engine having a horizontal output shaft rotatably coupled to a pump structured to drive a flow of water, an exhaust system attached to an exhaust port of the engine, a housing including multiple walls extending from a base and joining at a top face. The walls enclose the engine, exhaust system, and the pump, and further include multiple vents structured to allow a flow of outside air into and out of the housing. The pressure washer system further includes an engine cooling system including one or more air flow passageways, and a fan rotatably coupled to the horizontal output shaft. The air flow passageways are structured to pass the flow of outside air over the pump, internal combustion engine and exhaust system for cooling purposes. The fan drives the flow of outside air into the housing through air inlet vents, through the air flow passageway and out of the housing through opposing air outlet vents.

Another embodiment of the invention relates to an enclosure for a pressure washer system. The enclosure includes a base and multiple sidewalls extending from the base. The sidewalls include at least a front wall, a rear wall, a left wall, and a right wall. The sidewalls further include sound-absorbing material. The enclosure further includes a top surface supported by one or more of the sidewalls, multiple wheels connected to the base, an accessory rack, a storage area connected to the front wall, a handle, a vibration absorbing component attached to the base, and multiple side panels structured to attach to the left wall and right wall. The side panels are removable.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a front perspective view of the quiet pressure washer, according to an exemplary embodiment.

FIG. 2 is an exploded front perspective view of the pressure washer of FIG. 1.

FIG. 3 is a top view, side view and front view of the pressure washer of FIG. 1.

FIG. 4 is a front perspective view of the pressure washer of FIG. 1.

FIG. 5 is a front perspective view of the pressure washer of FIG. 1.

FIG. 6 is a front perspective view of the pressure washer of FIG. 1.

FIG. 7 is a side view of the pressure washer of FIG. 1.

FIG. 8 is a rear perspective view of the pressure washer of FIG. 1.

FIG. 9 is a side sectional view of the interface between the engine and the pump of the pressure washer of FIG. 1.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Referring to the figures generally, a pressure washer system is shown. The pressure washer system includes a housing which contains an internal combustion engine, pump, and an exhaust system. The housing further includes removable side panels and sound-absorbing material built into the walls to reduce the noise output of the pressure washer system while in operation. In order to reduce the likelihood that the pressure washer system overheats due to the presence of the sound-absorbing material, a love joy joint is rotatably coupled to the internal combustion engine. A sensor is coupled to the inlet of the pump. The sensor reads the flow rate data of the water and interfaces with a controller to adjust the operation of an air-fuel mixing device configured to adjust the operation of the internal combustion engine. This reduces the speed of the internal combustion engine when the flow rate of water through the inlet is low, thereby reducing the noise from the pressure washer system when there is little or no demand for a flow of water. The housing further comprises a retractable telescoping handle, a plurality of wheels, a rubber base, a front storage section and various connection options and storage areas. Therefore, the pressure washer system has reduced noise while operating as well as additional storage areas and an overall more compact design.

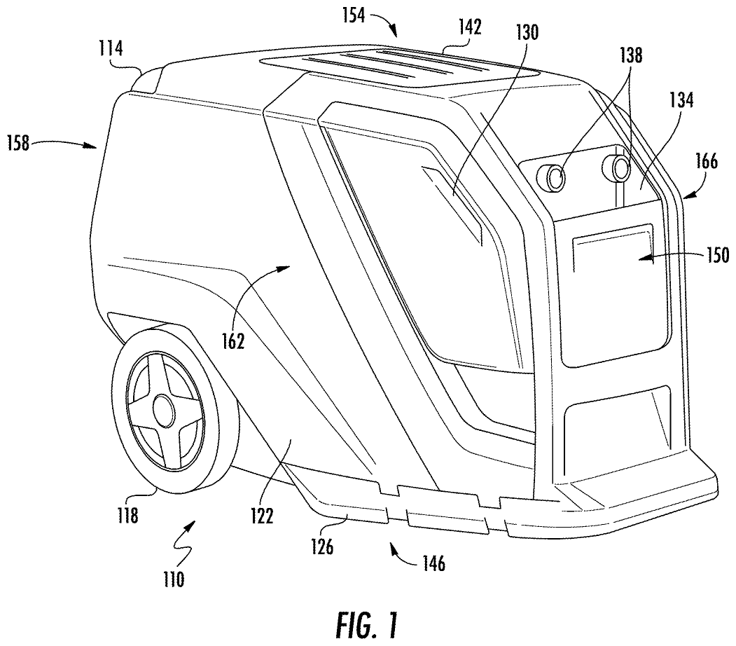

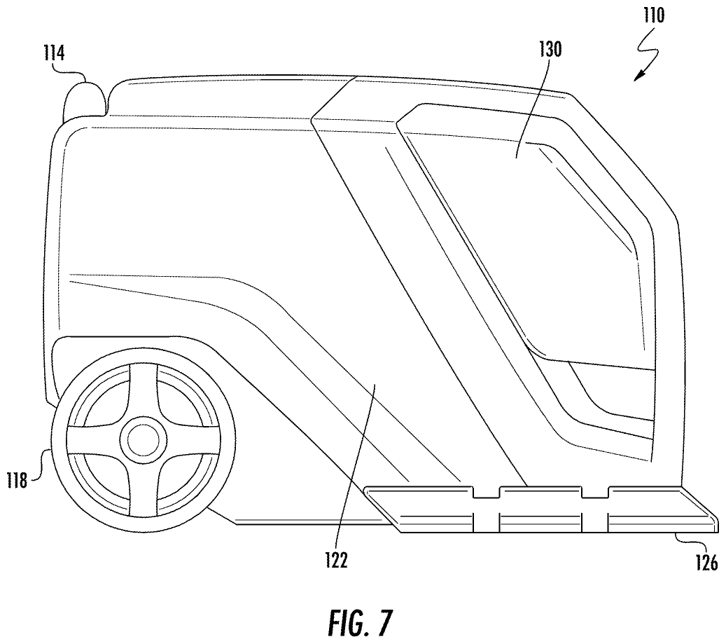

Referring to FIG. 1, a pressure washer system 110 includes a retractable telescoping handle 114, a housing 122, a plurality of wheels 118 (only one wheel shown), a front 150, a rear 158, a top 154, a bottom 146, a left side 166 and a right side 162. As shown in FIGS. 1 and 7, the housing 122 is configured to couple to a rubber base 126 which absorbs vibration of the pressure washer system 110 during use and prevents the pressure washer system 110 from moving while the engine (not shown) is in an operational state. The rubber base 126 may also include isolator mounts (not shown) to prevent the pressure washer system 110 from walking or moving during operation. In some embodiments, the isolator mounts may be present while the rubber base 126 is not present. In some embodiments the isolator mounts may be used in addition to the rubber base 126. The plurality of wheels 118 are configured such that they do not contact the ground while the pressure washer system 110 is in operation. The plurality of wheels are further configured to contact the ground when the retractable telescoping handle 114 is extended and a force is applied to the end of the handle such that it causes the pressure washer system 110 to tilt back (where tilting back is the motion that causes the end with the rubber base 126 to lift off the ground while the plurality of wheels 118 or any part of the pressure washer system 110 on the end proximate the plurality of wheels 118 contacts the ground). In some embodiments, the plurality of wheels 118 may contact or lift off of the ground via a mechanism (not shown) in response to the retractable telescoping handle 114 being extended or retracted. In some embodiments, the plurality of wheels 118 may be configured to always contact the ground. In some embodiments, the plurality of wheels 118 are positioned proximate both the front and rear ends of the pressure washer system 110.

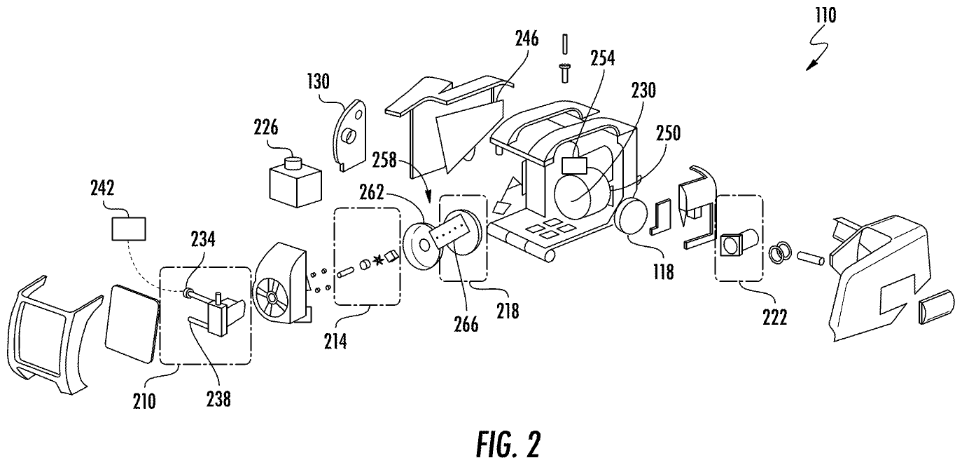

The housing 122 is further configured to interface with a plurality of removable side panels 130 such that the removable side panels 130 can be attached or removed for branding purposes or for easy access to the internal components. The removable side panels 130 are positioned on the left side 166 and right side 162 of the pressure washer system 110. The housing 122 also comprises a front storage section 134 which can store various tools, hoses, attachments, etc. This added storage is advantageous since many pressure washers do not include additional storage areas. This front storage section 134 may include a molded piece, an elastic piece, etc., and is open at the top. In some embodiments, a lid is attached to the top of the front storage section 134. This may be a hinged lid, or an interlocking lid which may be secured in a closed position with one or more latches, locking devices, etc. Above the front storage section 134 are one or more connection options 138 which connect hoses to a pump 210 (FIG. 2). In some embodiments, one or more or all of these connection options 138 may be positioned on the sides of the pressure washer system 110 or on the top 154 or rear 158 of the pressure washer system 110 or may extend through any other surface of the housing 122. These connection options 138 may be angled downward or away from the user to prevent spray from hitting the user. On the top of the pressure washer system 110 is an accessory rack 142. This accessory rack 142 may be used to selectively hold tools, hoses, attachments, etc., or to mount accessories (e.g., lights, containers, etc.).

The parts of the housing 122 which enclose the internal combustion engine and a muffler 250 (or any exhaust system) contain sound-absorbing material 246 in order to reduce the volume of the pressure washer system 110 during use. In some embodiments, the sound-absorbing material 246 also or only surrounds the pump 210 or any other internal component. In some embodiments, the sound-absorbing material 246 may be replaced by one or more sound cancelling devices (e.g., devices which cause destructive interference of the soundwaves). In some embodiments, these sound cancelling devices may be used in addition to the sound-absorbing material 246. According to some embodiments, a sound absorbing case (not shown) is contained within the housing 122 and surrounds the engine and muffler 250 while still being configured to allow the exhaust gas from the muffler 250 to exit the case and the housing 122. The sound absorbing case contains one or more walls which include sound absorbing material. In some embodiments, the entire housing 122 comprises sound absorbing material, while in some embodiments only parts or none of the housing 122 comprise sound absorbing material.

In some embodiments, the housing 122 comprises a plurality of curved walls. Curved walls are advantageous, since they may reduce the vibration of the pressure washer system 110 during operation. Curved walls may be used in any of the embodiments disclosed. They may be used in addition to the sound absorbing material 246 or they may be used without the sound absorbing material 246. One or more or all of the walls of the housing 122 may be curved. Any other walls or surfaces in the pressure washer system 110 may be curved to reduce noise output.

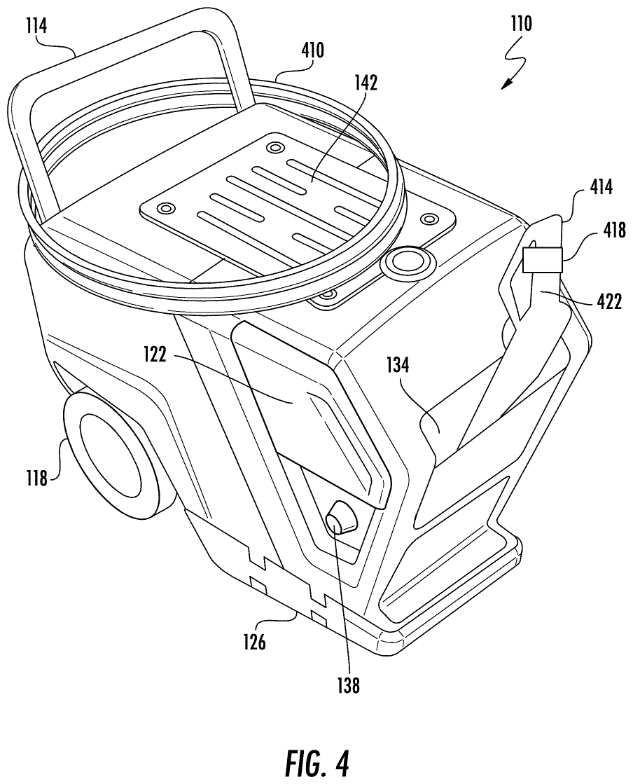

Referring now to FIG. 2, the pressure washer system 110 is shown in an exploded perspective view. An internal combustion engine 230 is rotatably coupled to a flywheel 218. A starter 222 (e.g., an electric motor) is configured to rotate the flywheel 218 by drawing energy from a power source (e.g., a removable battery contained in the housing 122) to start the internal combustion engine 230. In some embodiments, the starter 222 is further configured to start the internal combustion engine 230 based on the state of a push-button start (not shown), a key start (not shown) or any other starting device (e.g., the electric motor rotates the flywheel and starts the engine when the push-button is in a depressed state, or the key start is in a “start” position). In some embodiments, the starter 222 is a recoil starting system. The pump 210 is rotatably coupled to the internal combustion engine 230 via a love-joy joint 214 and may be directly mounted to the blower housing (not shown). In some embodiments, the love joy joint 214 is replaced by any other jaw inter-locking rotational joint. The love-joy joint 214 may reduce the heat transfer (e.g. conductive heat transfer) from the internal combustion engine 230 to the pump 210 due to the lack of a metallic connection in the love-joy joint 214. By using the love-joy joint 214, the likelihood of the pressure washer system 110 overheating is reduced. In addition, the love-joy joint 214 positions the pump 210 a greater distance away from the internal combustion engine 230 therefore reducing the convective and/or radiant heat transfer from the internal combustion engine 230 to the pump 210. Using the love-joy joint 214 may remove the need for a thermal relief valve which may be present on an inlet 234 of the pump 210 or on the pump inlet side of a bypass circuit (i.e., loop) which recirculates water through the pump when the internal combustion engine 230 is in an operational state but the pressure washer sprayer is off (e.g., a trigger 422 of a pressure washer spray gun 414 is not depressed as shown in FIG. 4). Reducing the heat transfer from the internal combustion engine 230 to the pump 210 may increase the lifetime of the pump 210 by eliminating the exposure of the seals/check valves to high temperatures and thus prolonging the life of the seals and/or check valves.

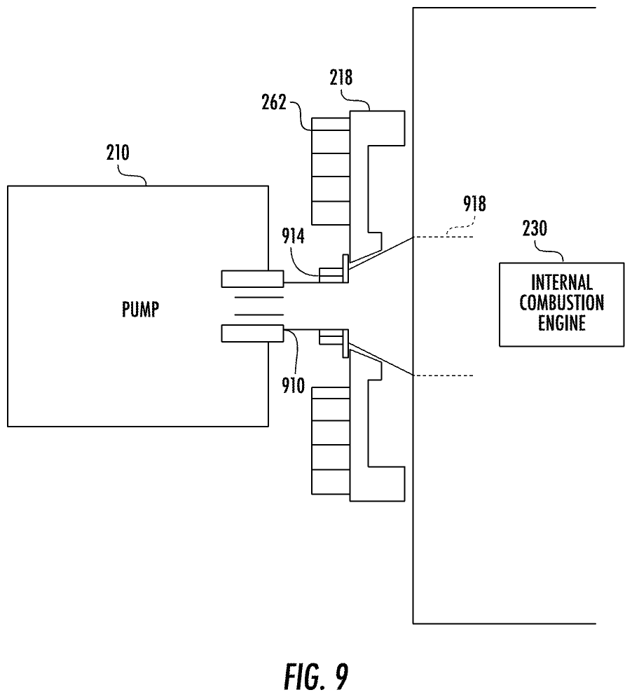

In some embodiments the internal combustion engine 230 is a horizontally-shafted internal combustion engine and may have an output shaft 918 (FIG. 9) on only one side. This may enable an overall smaller and more compact pressure washer system 110 as opposed to using a vertically-shafted internal combustion engine. According to some embodiments, the internal combustion engine 230 is mounted to the frame (not shown) by rubber mounts (not shown).

In some embodiments, the internal combustion engine 230 may further be cooled by an air cooling system 258. Air is drawn into the housing 122 by a fan 262 which is rotatably coupled to output shaft 918 (FIG. 9) of the internal combustion engine 230. The fan 262 draws air in one direction through inlet vents, over the pump 210, the internal combustion engine 230, and the muffler 250. The air is then driven by the fan 262 out of the housing 122 through outlet vents. This results in a uni-directional airflow, entering through the vents on one end of the housing 122, cooling the internal components, and exiting through the vents on the other end of the housing 122. In some embodiments, the air may pass over the internal combustion engine 230 and the muffler 250 first, and then over the pump 210. The airflow may also be directed such that the air flows over the pump 210, internal combustion engine 230 and the muffler 250 at the same time or that the air flows in multiple directions. In some embodiments, a plurality of air passageways 266 may be used to cool the internal combustion engine 230, pump 210 and muffler 250, or any other internal components that require cooling. In some embodiments, the air passageways 266 may be ducts which allow air to pass over the internal combustion engine 230, or they may act as ducts and cool the internal combustion engine 230.

In some embodiments, some or all of the air is drawn by the fan 262 over the pump 210 and into an air-fuel mixing device (e.g., carburetor, electronic fuel injection, etc.), or some or all of the air may bypass the fan 262 and be drawn directly into the air-fuel mixing device. This air is then mixed with the fuel from a fuel tank 226 and burned in the internal combustion engine 230. The exhaust gases are then expelled from the internal combustion engine 230 through the muffler 250.

In some embodiments, the pump 210, the love-joy joint 214, the flywheel 218, and the fan 262 are all positioned on the same side of the internal combustion engine 230. Conventionally, some of these components may be positioned on different sides of the engine, however positioning all of them on the same side of the engine advantageously enables a more compact pressure washer system 110.

The pump 210 includes an inlet 234 and an outlet 238 which allow for the inflow and outflow of water, wherein the inlet 234 and outlet 238 deliver the flow of water to and from the connection options 138 (FIG. 1). A sensor 242 is positioned at the inlet 234 of pump 210 and determines flow rate data of the water entering the pump 210 from the water source. In some embodiments, the sensor may be placed at the outlet of the pump, downstream of an unloader valve, or at an ignition coil (not shown). According to some embodiments, multiple sensors are used, wherein the sensors may be positioned at the pump inlet 234 and the ignition coil. In some embodiments, the sensor reads information regarding the operation of the ignition coil(s). In some embodiments, the information that the sensor reads is the pressure that the water flows out of the pump at (either downstream of the unloader valve or before the unloader valve) or the flow rate of the water output from the pump (either downstream of the unloader valve or before the unloader valve). According to some embodiments, the sensor or sensors read information that is correlated to the flow of the water from the water source to the pump or from the pump to the sprayer. The information from the sensor is relayed to a controller 254. The controller 254 is configured to adjust the operation of the air-fuel mixing device based on, at least but not limited to, the information from the sensor, wherein the air-fuel mixing device is configured to control the operation of the internal combustion engine 230 by delivering a quantity of air-fuel mixture to the internal combustion engine 230. In some embodiments the controller 254 adjusts the operation of a stepper motor (not shown) configured to adjust the operation of the air-fuel mixing device. This allows the internal combustion engine 230 to idle-down to lower speeds when there is no flow of water through the inlet 234 or to reduce its engine speed when the flow of water through the inlet 234 is relatively low. This results in a reduction of noise output from the pressure washer system 110 when the required flow rate of the water to the pressure washer sprayer (e.g., the pressure washer spray gun 414 as shown in FIG. 4) is low or when it is not required at all (e.g., when the user does not pull the trigger 422 of the pressure washer spray gun 414). However, it allows the internal combustion engine 230 to continue running in a low load or no load case while improving efficiency and reducing the noise from the pressure washer system 110. Therefore, when there is no flow through the pump inlet, the internal combustion engine 230 will operate at a lower speed (e.g., at approximately 2000 revolutions per minute, “rpm”), and when there is a higher flow rate through the pump inlet (or out of the pump to the sprayer), the internal combustion engine 230 will operate at a higher speed (e.g., 3000 rpm) and the pump 210 outputs a higher pressure (e.g., 2800 pounds per square inch, “psi”) and a higher flowrate (e.g., 5 gallons per minute, “gpm”). In some embodiments, a sensor 418 (FIG. 4) is placed on the trigger 422 of the pressure washer spray gun 414. This sensor is configured to communicate information of the position of the trigger 422 (e.g., the trigger is 50% depressed, 75% depressed, fully depressed, etc.) to the controller 254.

In some embodiments, one or more manual selecting devices (not shown) control the operation of the air-fuel mixing device via the controller 254 and therefore control the speed of the internal combustion engine 230 and thus the operation of the pump 210. A manual selecting device may comprise a button, a plurality of buttons, a dial, a selector lever, a switch, a multi-position selector, etc. In some embodiments, a digital interface may be used. In some embodiments, there may be pre-defined modes of operation of which each comprise a specific speed of the internal combustion engine 230 and/or an output pressure of the water and the air-fuel mixing device operation required to achieve this. The manual selecting device may be used to select which of these pre-defined modes of operation the pressure washer system 110 should operate at (e.g., car washing mode, manual mode, change mode, quiet mode, high mode, medium mode, low mode, etc.), wherein each of these modes of operation signifies a particular engine speed and water pressure/water flow rate. The controller 254 may receive information from the manual selecting device or the sensor and control the air-fuel mixing device based on either of these. In some embodiments, the controller 254 may receive information from both the manual selecting device and the sensor and control the air-fuel mixing device based on both of these inputs. In some embodiments, the source of information that the controller 254 uses to control the air-fuel mixing device may depend on the mode of operation determined by one of the manual selecting devices (e.g., in manual mode the controller 254 controls the air-fuel mixing device based on one or more of the manual selecting devices and not the sensor, in quiet mode the controller 254 controls the air-fuel mixing device based on the sensor, etc.). In some embodiments, a separate manual selecting device may be used to determine if the controller 254 controls the air-fuel mixing device based on the sensor (i.e., a switch which turns “quiet mode” on or off for any of the other predefined operational modes determined by a dial, wherein “quiet mode” comprises using the sensor information to control the operation of the air-fuel mixing device in addition to the operational mode selected). In some embodiments, a manual selecting device is configured to operate the pressure washer system 110 at a higher efficiency mode.

Referring still to FIG. 2, some embodiments of the pressure washer system 110 contain a collection plate (not shown) attached to the bottom of the housing 122 configured underneath the internal combustion engine 230 and any fuel lines or fuel tanks. This collection plate serves to catch any fuel leaks and prevent them from falling onto the ground. The collection plate may also be configured to interface with an accessory rack (not shown), similar to accessory rack 142. In some embodiments, the accessory rack may serve a dual purpose, acting as both a collection plate and an accessory rack.

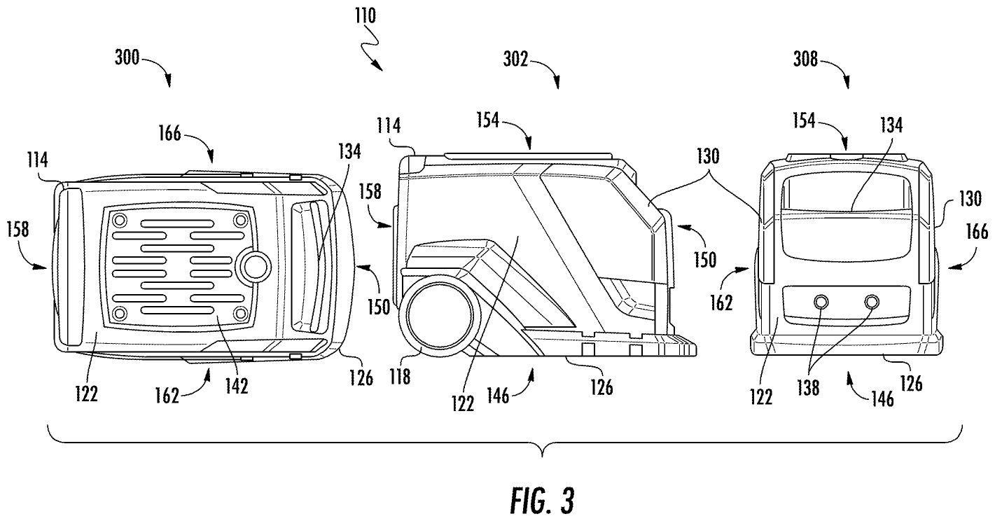

Referring now to FIG. 3, the pressure washer system 110 is shown from a top view 300, a side view 304, and a front view 308. As shown in the top view 300, the pressure washer system 110 includes the retractable telescoping handle 114, the accessory rack 142, the front storage section 134 and the rubber base 126. The side view 304 shows the pressure washer system 110 including the retractable telescoping handle 114 (where the retractable telescoping handle 114 is in a retracted position), the plurality of wheels 118, removable side panels 130, and the rubber base 126. The front view 308 shows the pressure washer system 110 including connection options 138, and the front storage section 134.

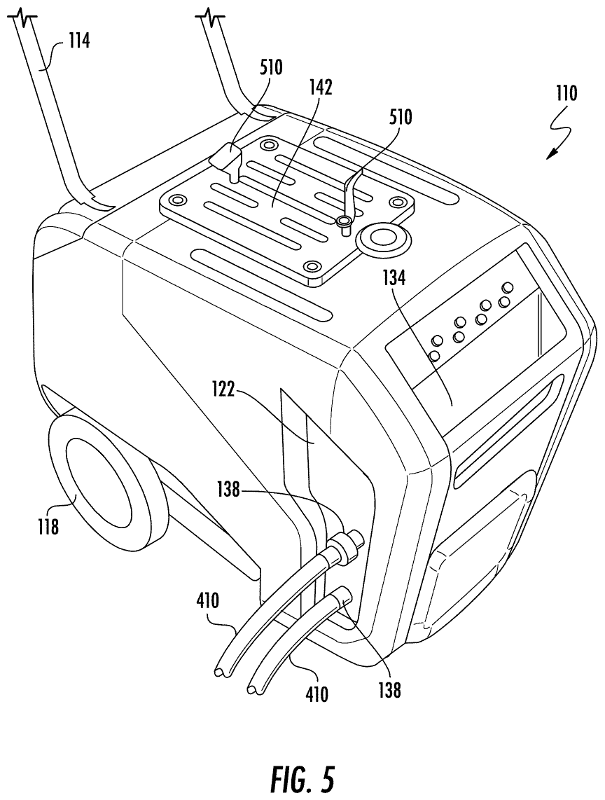

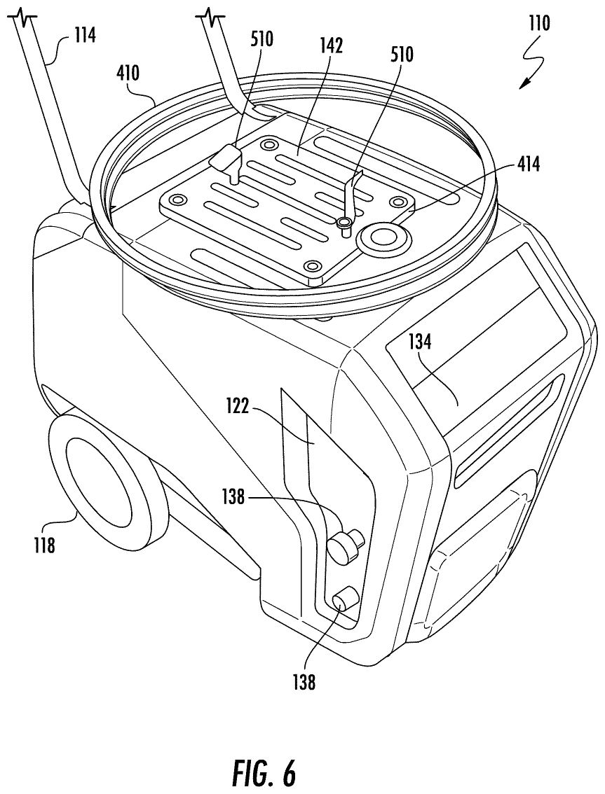

Referring now to FIGS. 4-7, the pressure washer system 110 can store or couple to various components. As shown in FIG. 4, the pressure washer system 110 is shown with the retractable telescoping handle 114 in a slightly extended position. Furthermore, a hose 410 is shown stored on accessory rack 142. The pressure washer spray gun 414 is also shown stored in the front storage section 134. In some embodiments, the pressure washer spray gun 414 includes a sensor 418 configured to sense the degree to which the trigger 422 has been depressed. Referring to FIG. 5, the pressure washer system 110 is shown with hose 410 connected to connection options 138. One or more attachment devices 510 are shown attached to accessory rack 142. These attachment devices 510 may be fastened or selectively attached to accessory rack 142 and may be clips, ratchets, latches, or any other device used to selectively attach an accessory to accessory rack 142. The retractable telescoping handle 114 is shown in an extended position. Referring to FIG. 6, the pressure washer system 110 is shown with hose 410 and pressure washer spray gun 414 selectively attached to accessory rack 142 via one or more attachment devices 510.

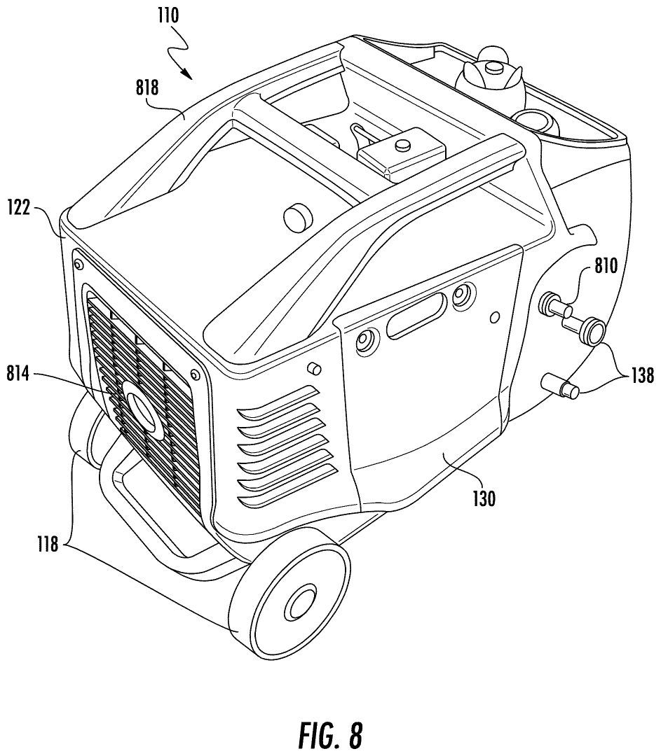

Referring now to FIG. 8, the pressure washer system 110 includes the plurality of wheels 118, removable side panels 130, and connection options 138. The pressure washer system 110 further comprises a key start 810, a plurality of vents 814, and a fixed handle 818 to make transporting the pressure washer system 110 easier. In some embodiments, the fixed handle 818 is not present at all, or is not present on the top and is replaced by an accessory rack 142. In some embodiments, the fixed handle 818 is attached to the front or rear or side walls. The key start 810 is configured to start the internal combustion engine (not shown) via an electric motor starting system. In some embodiments, the key start 810 may be replaced by a push button start or any other starting device, and the starting device (or key or push-button) may be positioned anywhere on the housing 122. Advantageously, an electric motor starting system removes the need for a recoil starting system. The vents 814 may be used to allow exhaust gas from the internal combustion engine to exit the housing 122. In some embodiments, the vents 814 may be used to allow the flow of air into the housing 122 for cooling purposes, or there may be a plurality of vents 814 wherein some of the vents 814 allow the flow of exhaust gas or air out of the housing 122 and some allow the flow of air into the housing 122. The vents 814 may also be positioned on any face or surface of the housing 122 such as the bottom 146, top 154, front 150, rear 158, left side 166 or right side 162, etc.

Referring now to FIG. 9, in some embodiments the pressure washer system 110 includes an extended output shaft 918 instead of the love-joy joint 214. The extended output shaft 918 is rotatably coupled to the internal combustion engine 230. According to some embodiments, extended output shaft 918 is horizontally oriented. As an alternative to the use of the love-joy joint 214, the extended output shaft 918 reduces the radiative and conductive heat transfer from the internal combustion engine 230 to the pump 210 by positioning the internal combustion engine 230 a distance away from the pump 210. In some embodiments, a nut 914 is used to couple the flywheel 218 to the extended output shaft 918. In some embodiments, the nut 914 is used to couple the fan 262 to the extended output shaft 918. In some embodiments, the extended output shaft 918 is rotatably coupled to the pump 210 with a spline 910 or a keyway (not shown).

The construction and arrangements of the pressure washer, as shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

References herein to the positions of elements (e.g., “top,” “bottom,” “above,” “below,” etc.) are merely used to describe the orientation of various elements in the Figures. It should be noted that the orientation of various elements may differ according to other example embodiments, and that such variations are intended to be encompassed by the present disclosure. Further, the formation of a passage by one or more surfaces can comprise a wide variety of passage cross-sectional shapes, for example, passages having circular, rectangular, oval, etc. cross-sectional shapes.

As utilized herein, the term “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed (e.g., within plus or minus five percent of a given angle or other value) are considered to be within the scope of the invention as recited in the appended claims. The term “approximately” when used with respect to values means plus or minus five percent of the associated value.

The terms “coupled” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It is important to note that the construction and arrangement of the various example embodiments are illustrative only. Although only a few embodiments have been described in detail in this disclosure, those skilled in the art who review this disclosure will readily appreciate that many modifications to the flow structures are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Additionally, features from particular embodiments may be combined with features from other embodiments as would be understood by one of ordinary skill in the art. Other substitutions, modifications, changes and omissions may also be made in the design, operating conditions and arrangement of the various example embodiments without departing from the scope of the present invention.

What is claimed is:

1. An enclosed pressure washer system, the enclosed pressure washer system comprising:
an internal combustion engine comprising a horizontal output shaft;
an exhaust system, wherein the exhaust system comprises a muffler and an exhaust outlet port in the muffler;
a fan rotatably coupled to the horizontal output shaft;
a starting system structured to start the engine, wherein the starting system comprises:
a flywheel rotatably coupled to the engine;
a battery; and
a starting device structured to start the engine by rotating the flywheel;
a pump rotatably coupled to the engine via a non-metallic connector and comprising:
an inlet, which water enters from an inlet conduit; and
an outlet, which pressurized water exits to an outlet conduit; and
an enclosure structured to house the engine, muffler, and pump, wherein the enclosure comprises a sound absorbing case which surrounds the engine, pump, and the muffler and allows the exit of exhaust gas;
wherein the pump, flywheel, and fan are positioned on a side of the engine proximate the horizontal output shaft.

2. The enclosed pressure washer system of claim 1, wherein the starting system is structured to start based on the state of at least one of a push button start, a key start, and a rope pull start.

3. The enclosed pressure washer system of claim 1, wherein the enclosed pressure washer system further comprises a sensor structured to determine a flow rate value of water flowing into the pump through the inlet conduit and a controller structured to adjust the operation of the engine based on at least one of the flow rate value of the water in the inlet conduit and a signal indicative of a selection from a manual selector.

4. The enclosed pressure washer system of claim 1, wherein the non-metallic connector between the engine and the water pump is a love-joy connection.

5. The enclosed pressure washer system of claim 4, wherein the love joy connection is structured to reduce heat transfer from the engine to the pump by dissipating heat and configuring the pump a distance away from the engine.

6. The enclosed pressure washer system of claim 3, wherein the sensor is positioned at the pump inlet and is structured to communicate information indicative of the flow rate of water to the controller.

7. The enclosed pressure washer system of claim 3, wherein the sensor is positioned at an ignition coil and is structured to sense a load on the engine and communicate load information to the controller.

8. The enclosed pressure washer system of claim 3, wherein the controller adjusts the operation of the engine by adjusting the operation of an air-fuel mixing device, wherein the air-fuel mixing device is structured to control the operation of the engine.

9. The enclosed pressure washer system of claim 7, wherein the controller adjusts the operation of the air-fuel mixing device by adjusting the operation of a stepper motor structured to adjust the operation of the air-fuel mixing device.

10. The enclosed pressure washer system of claim 1, wherein the enclosure comprises:
a sound absorbing case which surrounds the engine and the muffling device and comprises an aperture to allow the exhaust outlet port to exhaust through the sound absorbing case;
a rubber base which absorbs vibration of the enclosed pressure washer system while the engine is in an operational state;
a plurality of walls extending from the base;
a plurality of wheels;
an accessory rack;
a storage rack;
a telescoping handle, wherein the telescoping handle is structured to be collapsible; and
a plurality of removable side panels.

11. The enclosed pressure washer system of claim 1, wherein the manual selector is at least one of a switch, a button, a multi-mode button, and a dial.

12. The enclosed pressure washer system of claim 1, wherein the enclosed pressure washer system further comprises an air-cooling system, comprising a plurality of vents in the enclosure, an air-passageway structured to pass air over the pump, engine and exhaust system, and a fan to drive the flow of outside air through the vents and the air-passage way.

13. A pressure washer system, the pressure washer system comprising:
an internal combustion engine comprising a horizontal output shaft, wherein the horizontal output shaft is rotatably coupled to a pump structured to drive a flow of water;
an exhaust system attached to an exhaust port of the engine;
a housing, wherein the housing comprises a plurality of walls extending from a base and joining at a top face, enclosing the engine, exhaust system, and the pump, and further comprising a plurality of vents structured to allow a flow of outside air into and out of the housing; and
an engine cooling system, wherein the engine cooling system comprises:
one or more air flow passageways, wherein the air flow passageways are structured to pass the flow of outside air over the pump, internal combustion engine and exhaust system for cooling purposes; and
a fan rotatably coupled to the horizontal output shaft, wherein the fan drives the flow of outside air into the housing through air inlet vents, through the air flow passageway and out of the housing through opposing air outlet vents.

14. The pressure washer system of claim 13, wherein the pressure washer system further comprises a starting system, the starting system comprising:
a flywheel rotatably coupled to the horizontal output shaft;
an electric motor structured to start the internal combustion engine by rotating the flywheel; and
a battery structured to deliver power to the electric motor.

15. The starting system of claim 14, wherein the starting system further comprises at least one of a key start, a push-button start, and a rope pull start.

16. The pressure washer system of claim 13, wherein the flywheel, pump and fan are all rotatably coupled to the horizontal output shaft on the same side of the engine.

17. An enclosure for a pressure washer system, the enclosure comprising:
a base;
a plurality of sidewalls extending from the base, wherein the plurality of sidewalls includes at least a front wall, a rear wall, a left wall, and a right wall, wherein the plurality of sidewalls further comprise sound-absorbing material;
a top surface, wherein the top is supported by one or more of the sidewalls;
a plurality of wheels connected to the base;
an accessory rack;
a storage area connected to the front wall;
a handle;
a vibration absorbing component attached to the base; and
a plurality of side panels structured to attach to the left wall and right wall, wherein the plurality of side panels is removable.

18. The enclosure of claim 17, wherein the base comprises a plurality of isolator mounts.

19. The enclosure of claim 17, wherein the plurality of wheels is structured to contact a ground surface in response to the handle being extended and rocked back.

20. The enclosure of claim 17, wherein the wheels are structured to lift such that the wheels do not contact the ground during operation of the pressure washer system.
